(19) United States
(12) Patent Application Publication
(10) Pub. No.: US 2016/0195747 A1
(43) Pub. Date: Jul. 7, 2016

(54) LIQUID CRYSTAL DISPLAY AND METHOD OF MANUFACTURING THE SAME

(71) Applicant: Samsung Display Co., Ltd., Yongin-City (KR)

(72) Inventors: Tae Gyun KIM, Seoul (KR); Se Hee HAN, Seoul (KR); Tae Woon CHA, Seoul (KR)

(21) Appl. No.: 14/794,539

(22) Filed: Jul. 8, 2015

(30) Foreign Application Priority Data
Jan. 7, 2015 (KR) 10-2015-0002203

(51) Int. Cl. G02F 1/1368; G02F 1/1333; G02F 1/1341

(52) U.S. Cl. CPC G02F 1/1368; G02F 1/1341; G02F 1/133377; G02F 2001/133357

(57) ABSTRACT

A liquid crystal display according to exemplary embodiment of the present system and method includes: an insulating substrate; a thin film transistor positioned on the insulating substrate; a pixel electrode connected to the thin film transistor; a common electrode spaced apart from the pixel electrode while facing the pixel electrode; a liquid crystal layer injected into a microcavity between the pixel electrode and the common electrode; a roof layer formed on the common electrode; an injection hole positioned in the roof layer and the common electrode; an overcoat configured to cover the injection hole and partially overlap the roof layer; a film layer positioned on the overcoat and the roof layer; and a flattening layer positioned on the film layer.

### CROSS-REFERENCE TO RELATED APPLICATION

This application claims priority to and the benefit of Korean Patent Application No. 10-2015-0002203 filed in the Korean Intellectual Property Office on Jan. 7, 2015, the entire contents of which are incorporated herein by reference.

### BACKGROUND

(a) Field

The present disclosure relates to a liquid crystal display and a method of manufacturing the same.

(b) Description of the Related Art

A liquid crystal display is currently one of the most widely used flat panel displays, such as for computer monitors, televisions, mobile phones, and the like, and includes two display panels on which field generating electrodes, such as a pixel electrode and a common electrode, are formed, and a liquid crystal layer interposed therebetween. The liquid crystal display applies a voltage to the field generating electrodes to generate an electric field in the liquid crystal layer to determine the alignment of the liquid crystal molecules in the liquid crystal layer and thereby control the polarization of incident light to display an image.

The two display panels configuring the liquid crystal display may be formed of a thin film transistor array panel and a counter display panel. In the thin film transistor array panel, gate lines transmitting a gate signal and data lines transmitting a data signal are formed to cross each other. Also, a thin film transistor connected to the gate line and the data line, a pixel electrode connected to the thin film transistor, and the like may be formed in the thin film transistor array panel. A light blocking member, a color filter, a common electrode, and the like may be formed in the counter display panel. In some cases, the light blocking member, the color filter, and the common electrode may be formed in the thin film transistor array panel instead.

However, because two substrates are used and constituent elements are formed on each of the two substrates, the display device is heavy and thick, the manufacturing cost thereof is high, and the manufacturing process time is long.

The above information disclosed in this Background section is only for enhancement of understanding of the background of the present system and method and therefore may contain information that does not form the prior art that is already known in this country to a person of ordinary skill in the art.

### SUMMARY

The present system and method provide a display device that is manufactured by using one substrate, thereby decreasing its weight, thickness, manufacturing cost, and manufacturing process time, and a method of manufacturing the same.

The present system and method also provide a display device in which a polarizer is stably attached to a flat surface thereof.

The present system and method provide a display device whose quality does not deteriorate due to moisture permeation.

An exemplary embodiment of the present system and method provides a liquid crystal display, including: an insulating substrate; a thin film transistor positioned on the insulating substrate; a pixel electrode connected to the thin film transistor; a common electrode spaced apart from the pixel electrode while facing the pixel electrode; a liquid crystal layer positioned between the pixel electrode and the common electrode, and injected into a microcavity corresponding to one pixel; a roof layer formed on the common electrode; an injection hole positioned in the roof layer and the common electrode; an overcoat configured to cover the injection hole and partially overlap the roof layer; a film layer positioned on the overcoat and the roof layer; and a flattening layer positioned on the film layer.

The liquid crystal display may further include an inorganic layer positioned on the film layer.

The inorganic layer may include any one of an aluminum oxide (Al₂O₃) and a titanium oxide (TiO₂).

The inorganic layer may overlap the film layer in a vertical direction with respect to a planar surface of the insulating substrate on which the thin film transistor is positioned.

The film layer may be a thermosetting epoxy film.

The liquid crystal display may further include a metal layer positioned on the overcoat.

A material of the metal layer may include at least one of copper (Cu) and silver (Ag).

Another exemplary embodiment of the present system and method provides a method of manufacturing a liquid crystal display, including: forming a thin film transistor on an insulating substrate; forming a pixel electrode connected to the thin film transistor; forming a sacrificial layer on the pixel electrode; forming a common electrode and a roof layer including an injection hole on the sacrificial layer; forming a microcavity corresponding to each pixel between the pixel electrode and the common electrode by removing the sacrificial layer exposed through the injection hole; forming a liquid crystal layer by injecting a liquid crystal material into the microcavity; forming an overcoat partially overlapping the roof layer to seal the injection hole; stacking a film layer on the overcoat; and forming a flattening layer on the film layer.

The method may further include forming an inorganic layer on the film layer.

The inorganic layer may be formed by an atomic layer deposition (ALD) method, and may be formed to overlap the film layer in a vertical direction with respect to a planar surface of the insulating substrate on which the thin film transistor is formed.

The overcoat may be formed by a dispensing method.

The film layer may be a thermosetting film.

The method may further include forming a metal layer on the overcoat.

The metal layer may be formed by a dispensing method or an inkjet printing method.

The metal layer may have a thickness of about 1 μm or more.

According to exemplary embodiments of the present system and method, the weight, thickness, manufacturing cost, and manufacturing process time of a display device may be reduced by using one substrate.

Further, according to the exemplary embodiments of the present system and method, a flat surface is formed so that a polarizer may be stably attached thereon, thereby providing a liquid crystal display with improved durability and reliability.

### BRIEF DESCRIPTION OF THE DRAWINGS

FIG. 1 is a plane layout view of one pixel area according to an exemplary embodiment of the present system and method.

FIG. 2 is a cross-sectional view taken along line II-II of FIG. 1.

FIG. 3 is a cross-sectional view taken along line III-III of FIG. 1.

FIGS. 4, 6, 8, 10, and 12 are cross-sectional views taken along line II-II of FIG. 1 according to an exemplary manufacturing process.

FIGS. 5, 7, 9, 11, and 13 are cross-sectional views taken along line III-III of FIG. 1 according to an exemplary manufacturing process.

FIGS. 14 and 15 are cross-sectional views taken along lines II-II and III-III according to another exemplary embodiment of the present system and method.

FIGS. 16, 17A, 17B, 17C, 18A, 18B, 18C, 18D, 18E, 18F and 18G are images pertaining to observations of a display device according to an exemplary embodiment of the present system and method.

### DETAILED DESCRIPTION OF THE EMBODIMENTS

The present system and method are described more fully hereinafter with reference to the accompanying drawings in which exemplary embodiments of the system and method are shown. Those of ordinary skill in the art would realize that the described embodiments may be modified in various different ways without departing from the spirit or scope of the present system and method.

In the drawings, the thickness of layers, films, panels, regions, etc., are exaggerated for clarity. Like reference numerals designate like elements throughout the specification. When an element such as a layer, film, region, or substrate is referred to as being “on” another element, it may be directly on the other element, or intervening elements may also be present. In contrast, when an element is referred to as being “directly on” another element, there are no intervening elements present.

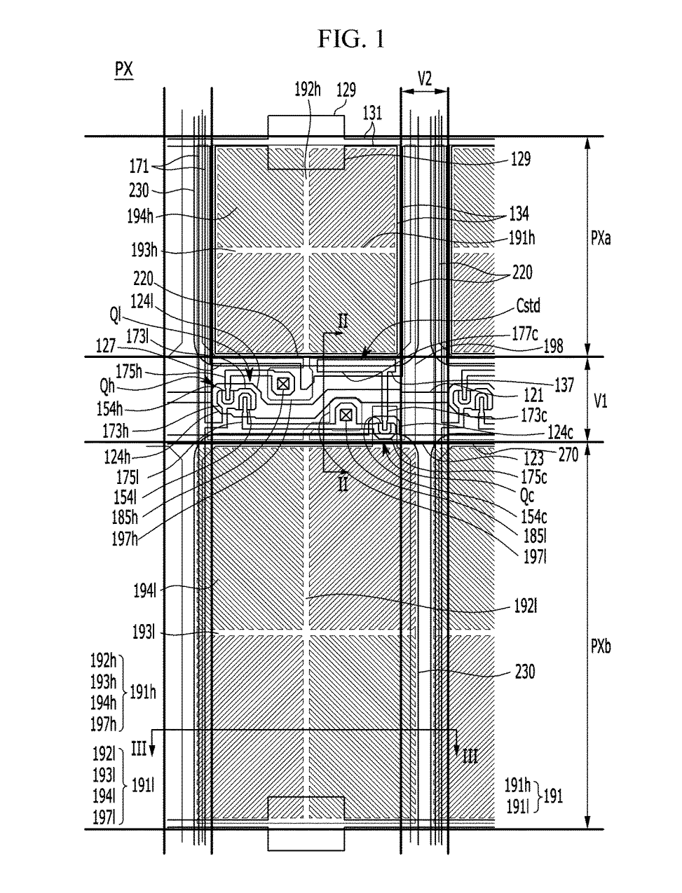

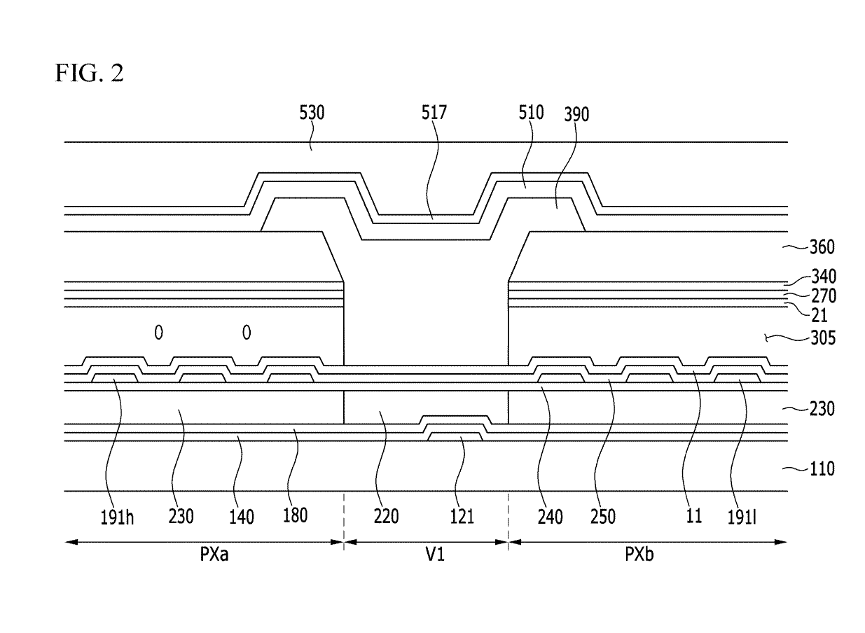

Hereinafter, a liquid crystal display according to an exemplary embodiment of the present system and method is described with reference to FIGS. 1 to 3. FIG. 1 is a plane layout view of one pixel area according to an exemplary embodiment of the present system and method. FIG. 2 is a cross-sectional view taken along line II-II of

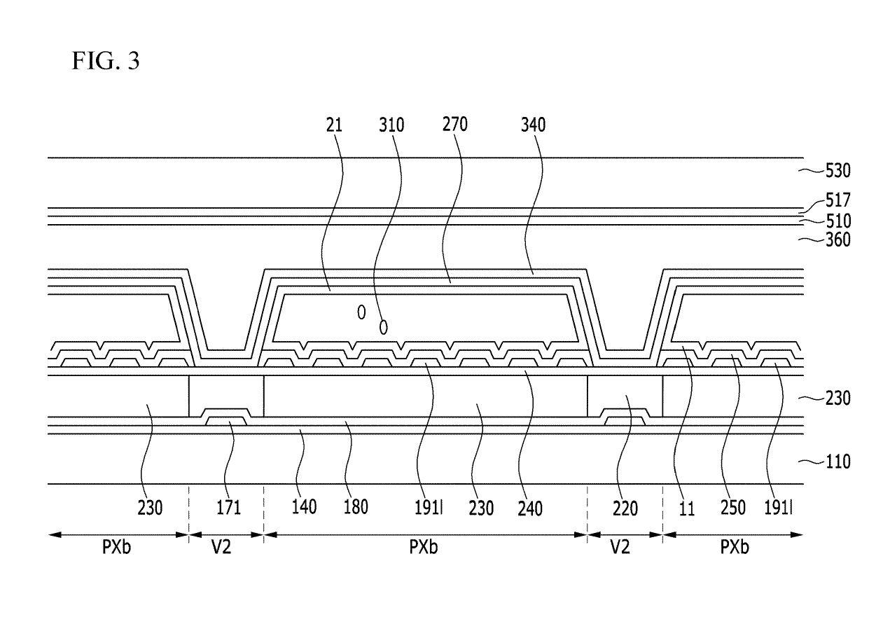

FIG. 1. FIG. 3 is a cross-sectional view taken along line III-III of FIG. 1.

First, a liquid crystal display according to an exemplary embodiment of the present system and method is described.

The liquid crystal display according to an exemplary embodiment of the present system and method includes an insulating substrate 110 formed of glass or plastic, and a roof layer 360 formed on the insulating substrate 110.

A plurality of pixel areas PX is positioned on the insulating substrate 110 and disposed in a matrix form including a plurality of pixel rows and a plurality of pixel columns. One pixel area PX is an area overlapping one pixel electrode and may include, for example, a first subpixel area PXa and a second subpixel area PXb. The first subpixel area PXa overlaps a first subpixel electrode 191h, and the second subpixel area PXb overlaps a second subpixel electrode 191l. The first subpixel area PXa and the second subpixel area PXb may be disposed in the lengthwise extension direction of a data line, which in the case of FIG. 1 is a vertical direction.

A first valley V1 is positioned between the first subpixel area PXa and the second subpixel area PXb in the lengthwise extension direction of a gate line, and a second valley V2 is positioned between columns of adjacent pixel areas.

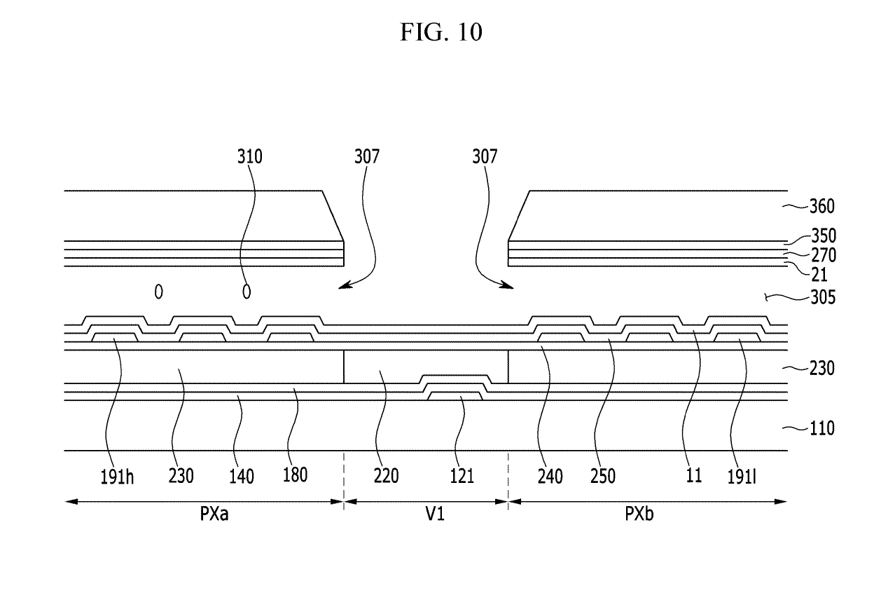

The roof layer 360 is formed in the lengthwise extension direction of the gate line. In this case, an injection hole 307 (see FIG. 10) through which the roof layer 360 is removed, so that constituent elements positioned under the roof layer 360 may be exposed, is formed in the first valley V1.

Each roof layer 360 is formed to be spaced apart from the substrate 110 between the adjacent second valleys V2 to form a microcavity 305. Further, each roof layer 360 is formed to be attached to the substrate 110 in the second valley V2 (i.e., not spaced apart by a microcavity) to cover both side surfaces of the microcavity 305.

The aforementioned structure of the display device is just an exemplary embodiment of the present system and method. Various modifications are feasible. For example, the manner in which the pixel area PX, the first valley V1, and the second valley V2 are disposed may be changed, the plurality of roof layers 360 may be connected to each other in the first valley V1, and some of the roof layers 360 may be formed to be spaced apart from the substrate 110 in the second valley V2 to connect the adjacent microcavities 305 to each other.

Referring to FIG. 2, a plurality of gate conductors including a plurality of gate lines 121, a plurality of voltage drop gate lines 123, and a plurality of storage electrode lines 131 is formed on the insulating substrate 110.

The gate line 121 and the voltage drop gate line 123 mainly extend in a horizontal direction and transmit a gate signal. The gate conductor further includes a first gate electrode 124h and a second gate electrode 124l protruding upwardly and downwardly (based on the orientation shown in FIG. 1) from the gate line 121, and further includes a third gate electrode 124c protruding upwardly from the voltage drop gate line 123. The first gate electrode 124h and the second gate electrode 124l are connected to each other to form one protrusion part. In this case, the manner, shape, etc., in which the first, second, and third gate electrodes 124h, 124l, and 124c protrude may be changed.

The storage electrode line 131 also mainly extends in the horizontal direction and transmits a predetermined voltage, such as a common voltage Vcom. The storage electrode line 131 includes a storage electrode 129 protruding protrudes upwardly and downwardly (based on the orientation shown in FIG. 1), a pair of vertical portions 134 that substantially extends vertically and downwardly with respect to the gate line 121, and a horizontal portion 127 through which ends of the pair of vertical portions 134 are connected to each other. The horizontal portion 127 includes a capacitive electrode 137 extended downwardly.

A gate insulating layer 140 is positioned on the gate conductor 121, 123, 124h, 124l, 124c, and 131. The gate insulating layer 140 may be formed of an inorganic insulating material, such as silicon nitride (SiNx) and silicon oxide (SiOx). Further, the gate insulating layer 140 may be formed of a single layer or multilayers.

A first semiconductor layer 154h, a second semiconductor layer 154l, and a third semiconductor layer 154c are positioned on the gate insulating layer 140. The first semiconductor layer 154h may be positioned on the first gate electrode 124h, the second semiconductor layer 154l may be positioned on the second gate electrode 124l, and the third semiconductor layer 154c may be positioned on the third gate electrode 124c. The first semiconductor layer 154h and the second semiconductor layer 154l may be connected to each other, and the second semiconductor layer 154l and the third semiconductor layer 154c may be connected to each other. Further, the first semiconductor layer 154h may also be formed to extend under and overlap the data line 171. The first to third semiconductor layers 154h, 154l, and 154c may be formed of amorphous silicon, polycrystalline silicon, a metal oxide, or the like.

Ohmic contacts (not illustrated) may be further formed on the first to third semiconductor layers 154h, 154l, and 154c. The ohmic contacts may be made of a material, such as n+ hydrogenated amorphous silicon on which silicide or an n-type impurity is doped at a high concentration.

Data conductors including the data line 171, a first source electrode 173h, a second source electrode 173l, a third source electrode 173c, a first drain electrode 175h, a second drain electrode 175l, and a third drain electrode 175c are formed on the first to third semiconductor layers 154h, 154l, and 154c.

The data line 171 transmits a data signal and mainly extends in a vertical direction to cross the gate line 121 and the voltage drop gate line 123. Each data line 171 includes the first source electrode 173h and the second source electrode 173l that extend toward the first gate electrode 124h and the second gate electrode 124l, respectively, and are connected to each other.

Each of the first drain electrode 175h, the second drain electrode 175l, and the third drain electrode 175c includes one wide end portion and a rod-shaped end portion. The rod-shaped end portion of the first drain electrode 175h and the second drain electrode 175l is partially surrounded by the first source electrode 173h and the second source electrode 173l, respectively. The one wide end portion of the second drain electrode 175l also extends to form the third source electrode 173c that is bent in a “U”-shape. A wide end portion 177c of the third drain electrode 175c overlaps the capacitive electrode 137 to form a voltage drop capacitor Cstd, and a rod-shaped end portion of the third drain electrode 175c is partially surrounded by the third source electrode 173c.

The first gate electrode 124h, the first source electrode 173h, the first drain electrode 175h, and the first semiconductor layer 154h together form a first thin film transistor Qh. The second gate electrode 124l, the second source electrode 173l, the second drain electrode 175l, and the second semiconductor layer 154l together form a second thin film transistor Ql. The third gate electrode 124c, the third source electrode 173c, the third drain electrode 175c, and the third semiconductor layer 154c together form a third thin film transistor Qc.

The first semiconductor layer 154h, the second semiconductor layer 154l, and the third semiconductor layer 154c may be formed to be connected with each other in a linear shape, and may have substantially the same planar shape as those of the data conductors 171, 173h, 173l, 173c, 175h, 175l, and 175c, and the ohmic contacts positioned underneath, including the channel areas between the source electrodes 173h, 173l, and 173c and the drain electrodes 175h, 175l, and 175c.

The first semiconductor layer 154h includes a portion that does is not covered by, or is free from overlap with, the first source electrode 173h and the first drain electrode 175h and is exposed between the first source electrode 173h and the first drain electrode 175h. The second semiconductor layer 154l includes a portion that is not covered by the second source electrode 173l and the second drain electrode 175l and is exposed between the second source electrode 173l and the second drain electrode 175l. The third semiconductor layer 154c includes a portion that is not covered by the third source electrode 173c and the third drain electrode 175c and is exposed between the third source electrode 173c and the third drain electrode 175c.

A passivation layer 180 is formed on the data conductors 171, 173h, 173l, 173c, 175h, 175l, and 175c, and on the portions of the semiconductor layers 154h, 154l, and 154c exposed between the source electrodes 173h, 173l, and 173c and the drain electrodes 175h, 175l, and 175c. The passivation layer 180 may be formed of an organic insulating material or an inorganic insulating material, and formed of a single layer or multilayers.

Next, color filters 230 and light blocking members 220 are positioned on the passivation layer 180. Each color filter 230 may display any one of several primary colors, such as three primary colors of red, green, and blue. The color filter 230, however, is not limited to the three primary colors of red, green and blue colors. For example, it may display cyan, magenta, yellow, and white-based colors.

The light blocking member 220 is positioned in the area overlapping where the thin film transistor is positioned. The light blocking member 220 may be positioned on a boundary portion of the pixel areas PX and the thin film transistor to prevent light leakage. The color filter 230 may be positioned in each of the first subpixel area PXa and the second subpixel area PXb, and the light blocking member 220 may be positioned between the first subpixel area PXa and the second subpixel area PXb.

The light blocking member 220 may be disposed between adjacent color filters and extend in the lengthwise extension direction of the gate line 121 and the voltage drop gate line 123 and the lengthwise extension direction of the data line 171. The light blocking member 220 may cover the areas where the first thin film transistor Qh, the second thin film transistor Ql, the third thin film transistor Qc, and the like are positioned. That is, the light blocking member 220 may be formed in the first valleys V1 and the second valleys V2. The color filter 230 and the light blocking member 220 may overlap each other in some areas.

The passivation layer 180, the color filter 230, and the light blocking member 220 are provided with a plurality of first contact holes 185h and a plurality of second contact holes 185l, through which the wide end portion of the first drain electrode 175h and the wide end portion of the second drain electrode 175l are exposed, respectively.

A first insulating layer 240 is positioned on the color filter 230 and the light blocking member 220, and a pixel electrode 191 is positioned on the first insulating layer 240. The pixel electrode 191 may be formed of a transparent metal material, such as an indium tin oxide (ITO) and an indium zinc oxide (IZO).

The pixel electrode 191 includes the first subpixel electrode 191h and the second subpixel electrode 191l, which are separated from each other with the gate line 121 and the voltage drop gate line 123 interposed therebetween. That is, the first subpixel electrode 191h and the second subpixel electrode 191l are disposed in the pixel area PX on opposite sides of the gate line 121 and the voltage drop gate line 123 to be adjacent to each other in the lengthwise extension direction of the data line. That is, the first subpixel electrode 191h and the second subpixel electrode 191l are separated from each other with the first valley V1 interposed therebetween, and the first subpixel electrode 191h is positioned in the first subpixel area PXa and the second subpixel electrode 191l is positioned in the second subpixel area Pxb.

The first subpixel electrode 191h and the second subpixel electrode 191l are connected with the first drain electrode 175h and the second drain electrode 175l through the first contact hole 185h and the second contact hole 185l, respectively. Accordingly, when the first thin film transistor Qh and the second thin film transistor Ql are in an on-state, the first subpixel electrode 191h and the second subpixel electrode 191l receive a data voltage from the first drain electrode 175h and the second drain electrode 175l, respectively.

An overall shape of each of the first subpixel electrode 191h and the second subpixel electrode 191l is a quadrangle. Each of the first subpixel electrode 191h and the second subpixel electrode 191l includes a cross-shaped stem portion formed by a horizontal stem portion (193h and 193l, respectively) and a vertical stem portion (192h and 192l, respectively) crossing the horizontal stem portion (193h and 193l, respectively). Further, each of the first subpixel electrode 191h and the second subpixel electrode 191l includes a plurality of fine branch portions (194h and 194l, respectively) and protruding portions (197h and 197l, respectively). The protruding portions 197h and 197l, as FIG. 1 shows, may protrude downwardly and upwardly from sides of the subpixel electrodes 191h and 191l, respectively, bordering the first valley V1.

Each of the subpixel electrodes 191h and 191l is divided into four subareas by the horizontal stem portion (193h and 193l, respectively) and the vertical stem portion (192h and 192l, respectively). The fine branch portions 194h and 194l obliquely extend from the horizontal stem portions 193h and 193l and the vertical stem portions 192h and 192l, respectively, and the extension direction thereof may form an angle of approximately 45° or 135° with respect to the gate line 121 or the horizontal stem portions 193h and 193l. Further, the fine branch portions 194h and 194l disposed in two adjacent subareas extend may in directions orthogonal to each other.

In the present exemplary embodiment shown in FIG. 1, the first subpixel electrode 191h further includes an outer peripheral stem portion surrounding an outer peripheral side thereof. Furthermore, the second subpixel electrode 191l includes horizontal portions positioned at an upper end and a lower end thereof, and left and right vertical portions 198 positioned at a left side and a right side of the first subpixel electrode 191h. The left and right vertical portions 198 may prevent capacitive coupling, for example, between the data line 171 and the first subpixel electrode 191h.

The manner in which the pixel area is disposed, the structure of the thin film transistor, and the shape of the pixel electrode described above are just one example. The present system and method are not limited thereto, and various modifications are feasible.

A second insulating layer 250 is positioned on the pixel electrode 191, and a common electrode 270 is positioned so as to be spaced apart from the pixel electrode 191 by a predetermined distance. The microcavity 305 is formed between the pixel electrode 191 and the common electrode 270. That is, the microcavity 305 is surrounded by the pixel electrode 191 and the common electrode 270, and is divided for each pixel. The dimensions (e.g., width and height) of the microcavity 305 may be variously modified according to the size and resolution of the display device.

The common electrode 270 may be formed of a transparent metal material, such as an indium tin oxide (ITO) and an indium zinc oxide (IZO). A predetermined voltage may be applied to the common electrode 270 to form an electric field between the pixel electrode 191 and the common electrode 270.

A first alignment layer 11 is formed on the second insulating layer 250. A second alignment layer 21 is formed under the common electrode 270 to face the first alignment layer 11.

The first alignment layer 11 and the second alignment layer 21 may be formed by a vertical alignment layer and formed of an alignment material, such as polyamic acid, polysiloxane, and polyimide. The first and second alignment layers 11 and 21 may be connected to each other at an edge surface of the pixel area PX.

A liquid crystal layer formed of liquid crystal molecules 310 is formed within the microcavity 305 positioned between the pixel electrode 191 and the common electrode 270. The liquid crystal molecules 310 may have negative dielectric anisotropy, and thus, may be oriented such that a long axis of the molecules 310 is aligned in a vertical direction with respect to the substrate 110 when an electric field is not applied. That is, vertical alignment may be implemented.

The first subpixel electrode 191h and the second subpixel electrode 191l to which the data voltage is applied generate an electric field together with the common electrode 270 to determine the alignment direction of the liquid crystal molecules 310 positioned within the microcavity 305 between the two electrodes 191 and 270. The luminance of light passing through the liquid crystal layer is changed according to the alignment direction of the liquid crystal molecules 310 determined as described above.

A third insulating layer 340 is further positioned on the common electrode 270. The third insulating layer 340 may be formed of an inorganic insulating material, such as a silicon nitride (SiNx), a silicon oxide (SiOx), a silicon nitride oxide (SiOxNy), and may be omitted in some cases.

The roof layer 360 is positioned on the third insulating layer 340 and may be formed of an organic material. The microcavity 305 may be formed under the roof layer 360. The color filter 230 may be hardened by a hardening process to maintain the shape of the microcavity 305. That is, the roof layer 360 is formed to be spaced apart from the pixel electrode 191 with the microcavity 305 interposed therebetween.

The roof layer 360 is formed in each pixel area PX and each second valley V2 in the lengthwise extension direction of the gate line in one pixel area and is not formed in the first valley V1. That is, the roof layer 360 is not formed between the first subpixel area PXa and the second subpixel area PXb. The microcavity 305 is formed under each roof layer 360 in each first subpixel area PXa and each second subpixel area PXb. The microcavity 305 is not formed under the roof layer 360 in the second valley V2, and the roof layer 360 is formed to be attached to the insulating substrate 110. Accordingly, the portion of the roof layer 360 positioned in the second valley V2 may be formed to be thicker than the portion of the roof layer 360 positioned in each first subpixel area PXa and each second subpixel area PXb. An upper surface and both side surfaces of the microcavity 305 are formed by the roof layer 360.

The injection hole 307 for exposing a part of the microcavity 305 is formed in the common electrode 270, the third insulating layer 340, and the roof layer 360 (see FIG. 10). The injection holes 307 may be formed to face each other at edges of the first subpixel area PXa and the second subpixel area PXb that border the first valley V1. That is, the injection hole 307 may be formed to expose the microcavity 305 through a lower side of the first subpixel area PXa and an upper side of the second subpixel area PXb. Because the microcavity 305 is exposed by the injection holes 307, an alignment agent, a liquid crystal material, or the like may be injected into the microcavity 305 through the injection holes 307.

An overcoat 390 is positioned on a third passivation layer 370. The overcoat 390 covers the injection hole 307 and thereby prevents the microcavity 305 from being exposed to the outside by the injection hole 307. The overcoat 390 seals the microcavity 305 so as to prevent the liquid crystal molecules 310 positioned inside the microcavity 305 from leaking to the outside. Since the overcoat 390 is in contact with the liquid crystal molecules 310, the overcoat 390 may be formed of a material that does not react with the liquid crystal molecules 310.

Further, according to an exemplary embodiment of the present system and method, the overcoat 390 may overlap a part of the roof layer 360. That is, the overcoat 390 may be formed on a part of the surface of the roof layer 360 to cover the injection hole 307, but not on the entire surface of the roof layer 360.

A film layer 510 may be positioned on the overcoat 390. According to an exemplary embodiment of the present system and method, the film layer 510 may be a thermosetting epoxy film. When an UV curable film is used, the liquid crystal layer may be influenced according to UV radiation.

According to an exemplary embodiment of the present system and method, the liquid crystal display may further an inorganic layer 517 positioned on the film layer 510. The inorganic layer 517 may be formed by an atomic layer deposition (ALD) method, and the inorganic layer 517 formed by the ALD method may be positioned between the molecules of the film layer 510. That is, the molecules forming the inorganic layer 517 may be formed to overlap the film layer 510 in a vertical direction with respect to the insulating substrate 110. The reason is that the ALD method for depositing the inorganic layer 517 allows molecules of the inorganic layer 517 to be positioned in spaces between the molecules of the film layer 510.

The inorganic layer 517 may include any one of an aluminum oxide (Al₂O₃) and a titanium oxide (TiO₂), but is not limited thereto, and may adopt any inorganic material which may be deposited by the ALD method.

In an exemplary embodiment of the present system and method, the inorganic layer 517 positioned on the overcoat 390 prevents moisture permeation, so that a separate inorganic layer positioned on the roof layer may be omitted.

Next, a flattening layer 530 is positioned on the inorganic layer 517 to flatten out any bumps caused by the plurality of underlying constituent elements. That is, the flattening layer 530 is formed on the inorganic layer 517 to create a uniformly-flat, upper surface. The flattening layer 530 may be formed of an organic material.

Although not illustrated in the drawings, a polarizer may be further formed on upper and lower surfaces of the display device. The polarizer may include a first polarizer and a second polarizer. The first polarizer may be attached onto a lower surface of the substrate 110, and the second polarizer may be attached onto the flattening layer 530.

According to an exemplary embodiment of the present system and method, a liquid crystal display may provide a flat surface by means of the flattening layer 530, so that the polarizer may be stably attached to the display panel.

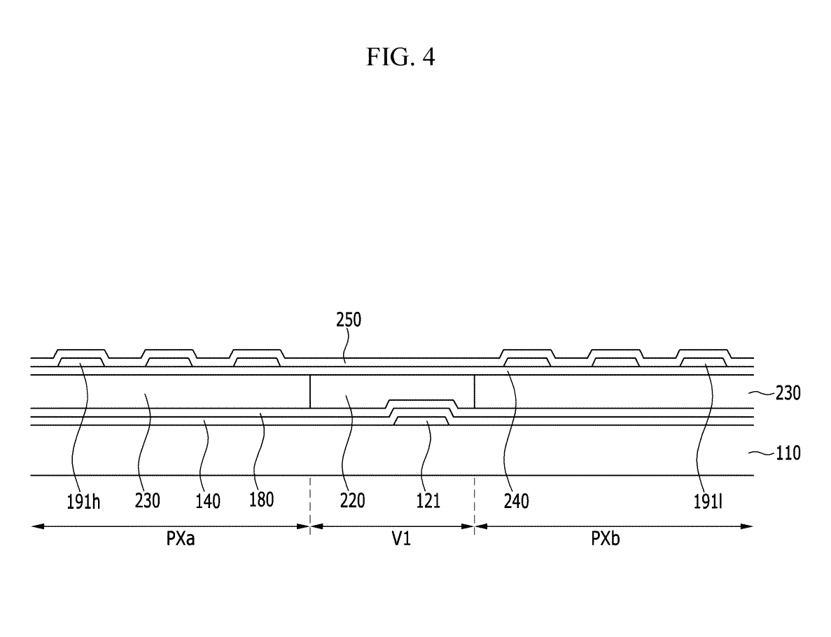

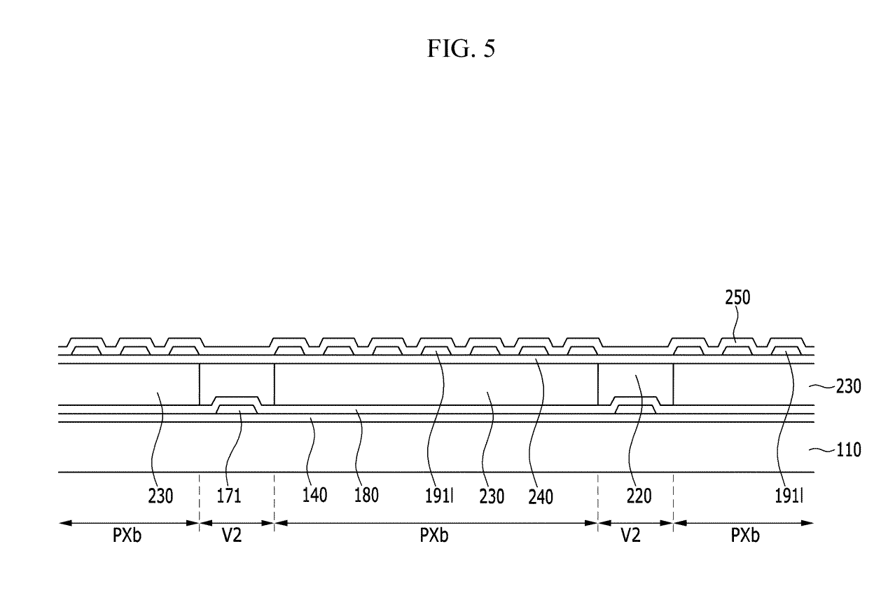

Hereinafter, a method of manufacturing a liquid crystal display according to an exemplary embodiment of the present system and method is described with reference to FIGS. 4 to 15. FIGS. 4, 6, 8, 10, and 12 are cross-sectional views taken along line II-II of FIG. 1 according to an exemplary manufacturing process. FIGS. 5, 7, 9, 11, and 13 are cross-sectional views taken along line III-III of FIG. 1 according to an exemplary manufacturing process.

First, as illustrated in FIGS. 4 and 5, the gate line 121 and the voltage drop gate line 123 are formed on the substrate 110 to extend in a predetermined direction. Formed along with the gate line 121 are the first gate electrode 124h, the second gate electrode 124l, and the third gate electrode 124c protruding from the gate line 121. The storage electrode line 131 may also be formed together to be spaced apart from the gate line 121, the voltage drop gate line 123, and the first to third gate electrodes 124h, 124l, and 124c. The substrate 110 may be formed of glass, plastic, or the like.

Subsequently, the gate insulating layer 140 is formed on the entire surface of the substrate 110 including the gate line 121, the voltage drop gate line 123, the first to third gate electrodes 124h, 124l, and 124c, and the storage electrode line 131 by using an inorganic insulating material, such as a silicon oxide (SiOx) or a silicon nitride (SiNx). The gate insulating layer 140 may be formed of a single layer or multilayers.

Subsequently, the first semiconductor layer 154h, the second semiconductor layer 154l, and the third semiconductor layer 154c are formed by depositing a semiconductor material, such as amorphous silicon, polycrystalline silicon, or a metal oxide, on the gate insulating layer 140, and then patterning the deposited semiconductor material. The first semiconductor layer 154h may be formed to be positioned on the first gate electrode 124h, the second semiconductor layer 154l may be formed to be positioned on the second gate electrode 124l, and the third semiconductor layer 154c may be formed to be positioned on the third gate electrode 124c.

Subsequently, the data line 171 extended in a direction different from that of the gate line is formed by depositing a metal material and then patterning the metal material. The metal material may be formed of a single layer or multilayers.

Further, the first source electrode 173h protruding from the data line 171 over the first gate electrode 124h and the first drain electrode 175h spaced apart from the first source electrode 173h are formed together. Further, the second source electrode 173l connected to the first source electrode 173h and the second drain electrode 175l spaced apart from the second source electrode 173l are formed together. Further, the third source electrode 173c extended from the second drain electrode 175l and the third drain electrode 175c spaced apart from the third source electrode 173c are formed together.

The first to third semiconductor layers 154h, 154l, and 154c, the data line 171, the first to third source electrodes 173h, 173l, and 173c, and the first to third drain electrodes 175h, 175l, and 175c may also be formed by continuously depositing a semiconductor material and a metal material and then simultaneously patterning the materials. The first semiconductor layer 154h may be formed to extend below the data line 171.

The first, second, and third gate electrodes 124h, 124l, and 124c, the first, second, and third source electrodes 173h, 173l, and 173c, the first, second, and third drain electrodes 175h, 175l, and 175c, and the first, second, and third semiconductor layers 154h, 154l, and 154c together configure the first, second, and third thin film transistors (TFT) Qh, Ql, and Qc, respectively.

Next, the passivation layer 180 is formed on the data line 171, the first to third source electrodes 173h, 173l, and 173c, the first to third drain electrodes 175h, 175l, and 175c, and portions of the semiconductor layers 154h, 154l, and 154c exposed between the first to third source electrodes 173h, 173l, and 173c and the first to third drain electrodes 175h, 175l, and 175c, respectively,

The passivation layer 180 may be formed of an organic insulating material or an inorganic insulating material, and formed of a single layer or multilayers.

Subsequently, the color filter 230 is formed in each pixel area PX on the passivation layer 180. The color filter 230 may be formed in each first subpixel area PXa and each second subpixel area PXb but not in the first valley V1. Further, the color filters 230 having the same color may be formed in a column direction of the plurality of pixel areas PX. In the case in which the color filters 230 having three colors are formed, after the color filter 230 having a first color is first formed, the color filter 230 having a second color may be formed by shifting a mask. Subsequently, after the color filter 230 having the second color is formed, the color filter 230 having a third color may be formed by shifting the mask.

Subsequently, the light blocking member 220 is formed on a boundary portion of each pixel area PX on the passivation layer 180 and the thin film transistor. The light blocking member 220 may also be formed in the first valley V1 positioned between the first subpixel area PXa and the second subpixel area PXb.

Although the color filter 230 is described above as being formed before the light blocking member 220 is formed, the present system and method are not limited thereto. For example, the light blocking member 220 may be formed before the color filter 230 is formed.

Subsequently, the first insulating layer 240 is formed of an inorganic insulating material, such as a silicon nitride (SiNx), a silicon oxide (SiOx), a silicon nitride oxide (SiOxNy), on the color filter 230 and the light blocking member 220.

Subsequently, the first contact hole 185h is formed to expose a part of the first drain electrode 175h and a second contact hole 185l is formed to expose a part of the second drain electrode 175l by etching the passivation layer 180, the light blocking member 220, and the first insulating layer 240.

Next the first subpixel electrode 191h is formed within the first subpixel area PXa and the second subpixel electrode 191l is formed within the second subpixel area PXb by depositing a transparent metal material, such as an indium tin oxide (ITO) and an indium zinc oxide (IZO), on the first insulating layer 240 and then patterning the transparent metal material. The first subpixel electrode 191h and the second subpixel electrode 191l are separated with the first valley V1 interposed therebetween. The first subpixel electrode 191h is formed to be connected to the first drain electrode 175h through the first contact hole 185h, and the second subpixel electrode 191l is formed to be connected to the second drain electrode 175l through the second contact hole 185l.

The first subpixel electrode 191h and the second subpixel electrode 191 are provided with the horizontal stem portions 193h and 193l and the vertical stem portions 192h and 192l crossing the horizontal stem portions 193h and 193l, respectively. Further, the plurality of fine branch portions 194h and 193l is formed to extend obliquely from the horizontal stem portions 193h and 193l and the vertical stem portions 192h and 192l, respectively.

Next, the second insulating layer 250 is formed on the pixel electrode 191 and the first insulating layer 240.

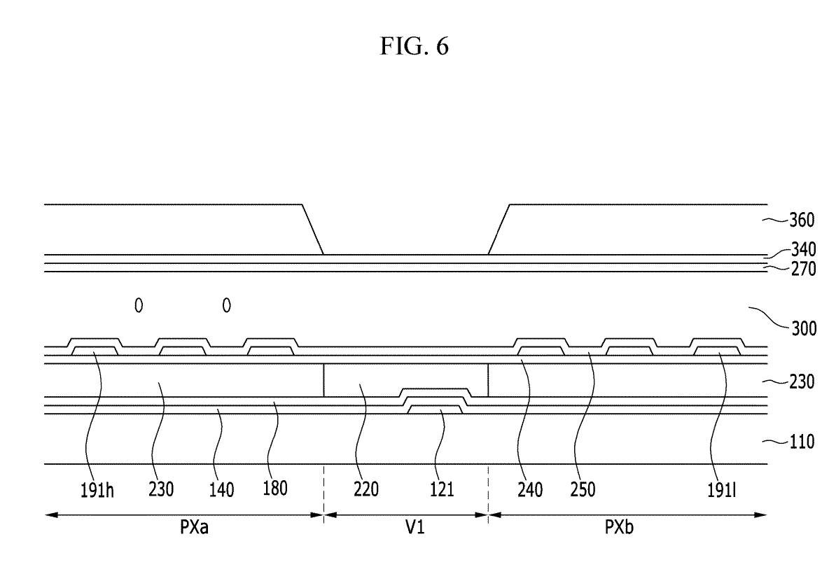

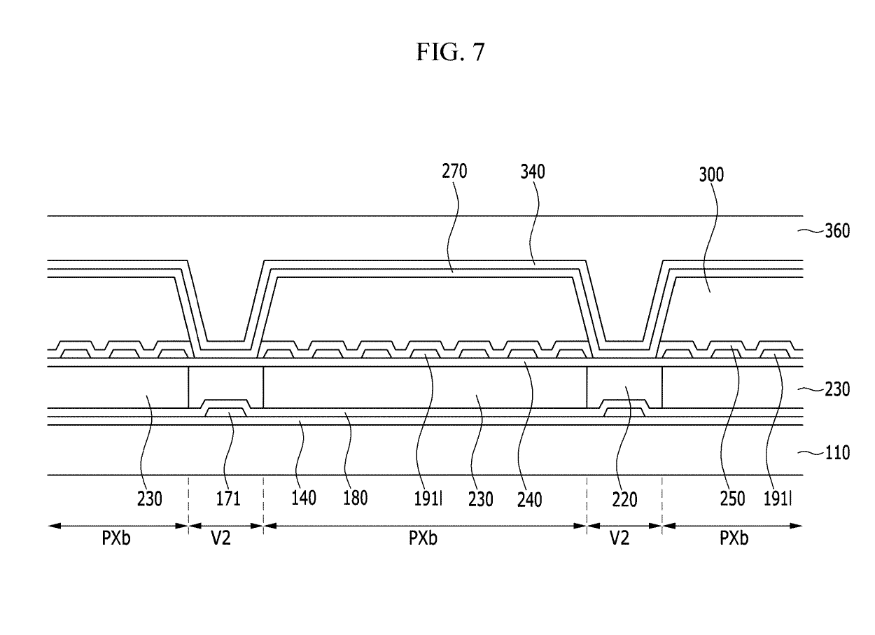

As illustrated in FIGS. 6 and 7, a photosensitive organic material is applied on the second insulating layer 250, and sacrificial layers 300 are formed through a photo process.

The sacrificial layers 300 are formed to be connected along a plurality of pixel columns. That is, the sacrificial layer 300 is formed to cover each pixel area PX and to cover the first valley V1 positioned between the first subpixel area PXa and the second subpixel area PXb.

Next, the common electrode 270 is formed by depositing a transparent metal material, such as an indium tin oxide (ITO) and an indium zinc oxide (IZO), on the sacrificial layer 300.

Next, the third insulating layer 340 may be formed on the common electrode 270 with an inorganic insulating material, such as a silicon nitride (SiNx), a silicon oxide (SiOx), a silicon nitride oxide (SiOxNy).

Next, the roof layer 360 is formed by applying an organic material onto the third insulating layer 340 and patterning the organic material. In this case, the organic material may be patterned so that the organic material positioned in the first valley V1 is removed. Accordingly, the roof layers 360 may be connected along the plurality of pixel rows.

That is, the roof layers 360 are not formed to be positioned in the first valley V1 areas, so that the roof layers 360 are spaced apart from each other with the first valley V1 areas interposed therebetween. Accordingly, an edge portion of the roof layer 360 in an area adjacent to the first valley V1 area is formed to have an inclined surface.

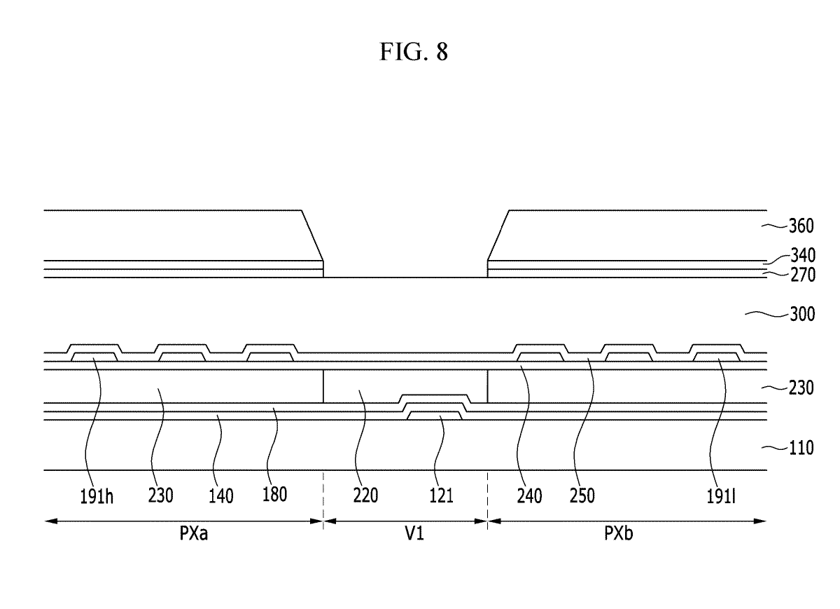

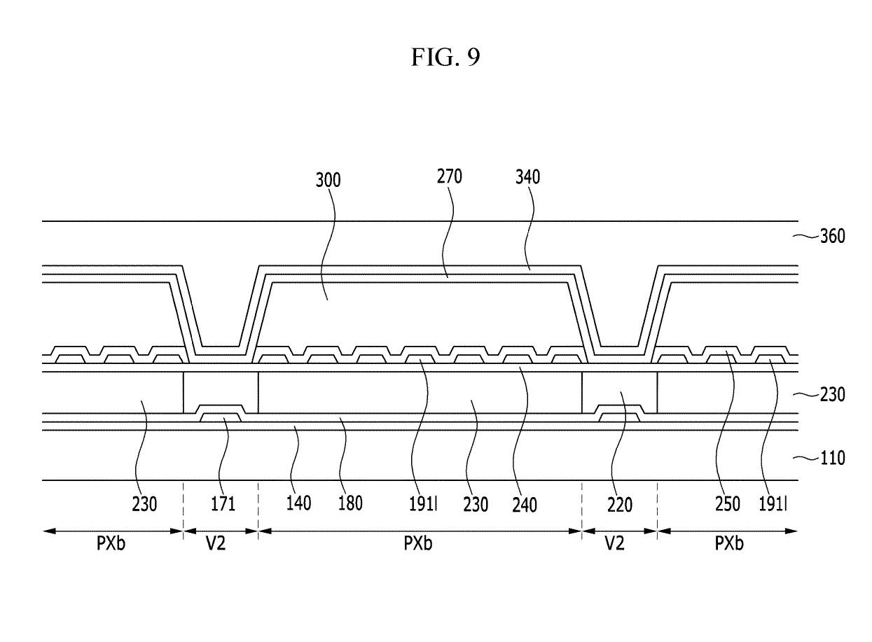

Next, as illustrated in FIGS. 8 and 9, the third insulating layer 340 and the common electrode 270 are patterned by using the roof layer 360 as a mask. First, the third insulating layer 340 is dry etched by using the roof layer 360 as a mask, and then the common electrode 270 is wet etched.

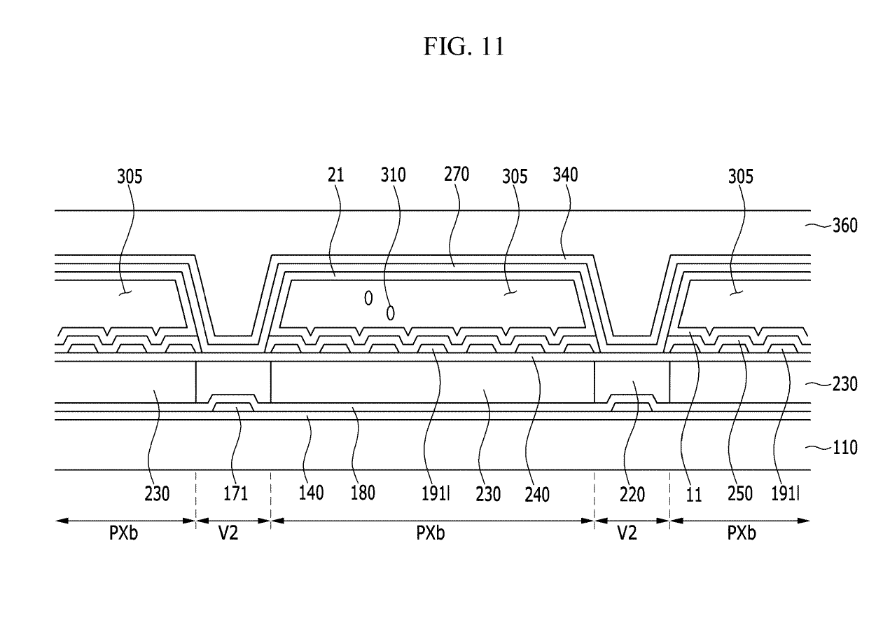

Next, as illustrated in FIGS. 10 and 11, the sacrificial layer 300 is completely removed by supplying a developer or a striper solution onto the substrate 110 on which the sacrificial layer 300 is exposed or by using an ashing process.

When the sacrificial layer 300 is removed, the microcavity 305 is formed in the space where the sacrificial layer 300 was positioned.

The pixel electrode 191 and the common electrode 270 are spaced apart from each other with the microcavity 305 interposed therebetween. Furthermore, the pixel electrode 191 and the roof layer 360 are spaced apart from each other with the microcavity 305 interposed therebetween. The common electrode 270 and the roof layer 360 are formed to cover an upper surface and both lateral surfaces of the microcavity 305.

The microcavity 305 is exposed to the outside through a portion in which the roof layer 360, the third insulating layer 340, and the common electrode 270 are removed, which is called the injection hole 307. The injection hole 307 is formed along the first valley V1. For example, the injection holes 307 may be formed to face each other at edges of the first subpixel area PXa and the second subpixel area PXb that border the first valley V1. That is, the injection hole 307 may be formed to expose the microcavity 305 at a lower side of the first subpixel area PXa and an upper side of the second subpixel area PXb. In another embodiment, the injection hole 307 may be formed along the second valley V2.

Subsequently, the roof layer 360 is cured by applying heat to the substrate 110 so that the shape of the microcavity 305 is maintained by the roof layer 360.

Subsequently, when an alignment agent including an alignment material is dropped onto the substrate 110 by a spin coating method or an inkjet method, the alignment agent is injected into the microcavity 305 through the injection hole 307. When a curing process is performed after the aligning agent is injected into the microcavity 305, a solution component of the alignment agent is vaporized and the alignment material remains on an inner wall surface of the microcavity 305.

Accordingly, the first alignment layer 11 may be formed on the pixel electrode 191, and the second alignment layer 21 may be formed under the common electrode 270. The first alignment layer 11 and the second alignment layer 21 are formed to face each other with the microcavity 305 interposed therebetween, and are formed to be connected to each other at the edge surfaces of the pixel area PX.

In this case, the first and second alignment layers 11 and 21 may be aligned in a direction that is vertical to the insulating substrate 110, except for the lateral surface of the microcavity 305. The first and second alignment layers 11 and 21 may be aligned in a direction that is horizontal to the insulating substrate 110 by additionally irradiating UV to the first and second alignment layers 11 and 21.

Subsequently, when the liquid crystal material formed of the liquid crystal molecules 310 is dropped onto the substrate 110 by an inkjet method or a dispensing method, the liquid crystal material is injected into the microcavity 305 through the injection hole 307. In this case, the liquid crystal material may be dropped onto the liquid crystal injection hole 307 formed along an odd numbered first valley V1, and may not be dropped onto the liquid crystal injection hole 307 formed along an even numbered first valley V1. Alternatively, the liquid crystal material may be dropped onto the liquid crystal injection hole 307 formed along an even numbered first valley V1, and may not be dropped onto the liquid crystal injection hole 307 formed along an odd numbered first valley V1.

When the liquid crystal material is dropped onto the injection hole 307 formed along the odd numbered first valley V1, the liquid crystal material enters the microcavity 305 through the injection hole 307 by capillary force. In this case, because air within the microcavity 305 is discharged through the injection hole 307 formed along the even numbered first valley V1, the liquid crystal material is able to enter the microcavity 305 with little or no resistance from air in the microcavity 305.

According to another embodiment, the liquid crystal material may be dropped onto all of the injection holes 307. That is, the liquid crystal material may be dropped onto all of the injection holes 307 formed along the odd numbered first valley V1 and the injection holes 307 formed along the even numbered first valley V1.

As described above, when the liquid crystal material is injected into the microcavity by capillary force, the liquid crystal dropped onto the injection hole 307 may partially contact and remain on the roof layer 360. Accordingly, the roof layer 360 having a large thickness and a small angle according to an exemplary embodiment of the present system and method may decrease the amount of liquid crystal material that would remain on the roof layer, thereby decreasing occurrences of a pixel defect.

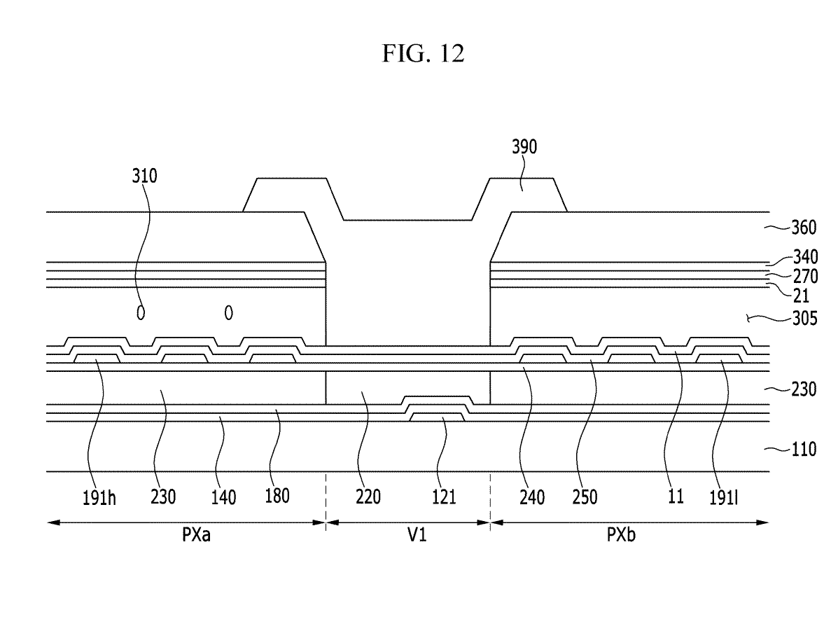

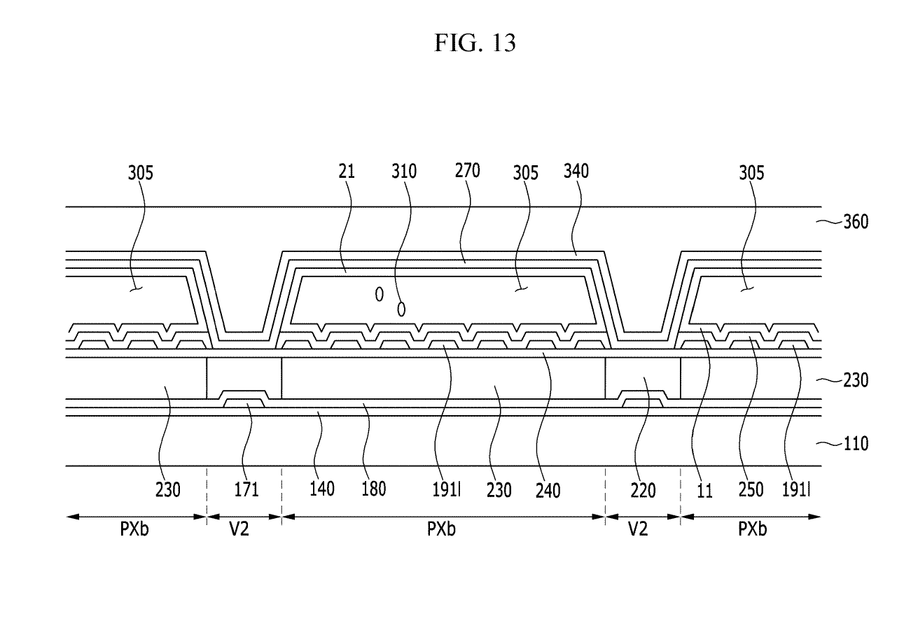

Next, as illustrated in FIGS. 12 and 13, the overcoat 390 is formed by depositing a material that does not react with the liquid crystal molecules 310 on the roof layer 360. The overcoat 390 is formed to cover the injection hole 307 and prevent the microcavity 305 from being exposed to the outside, thereby sealing the microcavity 305.

Particularly, the overcoat 390 according to an exemplary embodiment of the present system and method may overlap a part of the roof layer 360. The overcoat 390 may be formed without using a mask (e.g., by a dispensing method).

The overcoat 390 formed by the aforementioned method covers the injection hole 307 and overlaps only a part of the roof layer 360. That is, the overcoat 390 is not formed in an area of another roof layer 360 where the injection hole 307 is not positioned.

Next, the film layer 510, the inorganic layer 517, and the flattening layer 530 are sequentially stacked on the overcoat 390. According to the stacking structure, the single substrate liquid crystal display illustrated in FIGS. 2 and 3 is provided.

In this case, the film layer 510 according to an exemplary embodiment of the present system and method may be a thermosetting film. Accordingly, after the film layer 510 is stacked on the overcoat 390, the film layer 510 may be cured by performing a thermosetting process.

Next, an ALD method may be used to form the inorganic layer 517 on the film layer 510. The inorganic layer 517 formed by the aforementioned method may be positioned between the molecules of the film layer 510, and the molecules forming the inorganic layer 517 may be formed to overlap the film layer 510 in a direction vertical to a planar surface of the insulating substrate 110. The level of overlap between the inorganic layer 517 and the film layer 510 may be controlled according to a process.

The inorganic layer 517 may include any one of an aluminum oxide (Al₂O₃) and a titanium oxide (TiO₂), but is not limited thereto, and may adopt any inorganic material which may be deposited by the ALD method.

Then, the flattening layer 530 formed of an organic material is formed on the inorganic layer 517 to flatten steps or bumps that may occur on the surface of the inorganic layer 517. That is, the flattening layer 530 is formed on the inorganic layer 517 to create a uniformly-flat, upper surface.

Although not illustrated in the drawings, a polarizer may be further formed on upper and lower surfaces of the display device. The polarizer may include the first polarizer and the second polarizer. The first polarizer may be attached onto the lower surface of the substrate 110, and the second polarizer may be attached onto the flattening layer 530.

Thus, according to an exemplary embodiment of the present system and method, a liquid crystal display may provide a flat surface by means of the flattening layer 530, so that the polarizer may be stably attached to the display panel

Further, because the inorganic layer 517 is positioned at an outer (e.g., second outermost) surface of the liquid crystal layer, permeability of moisture is effectively controlled.

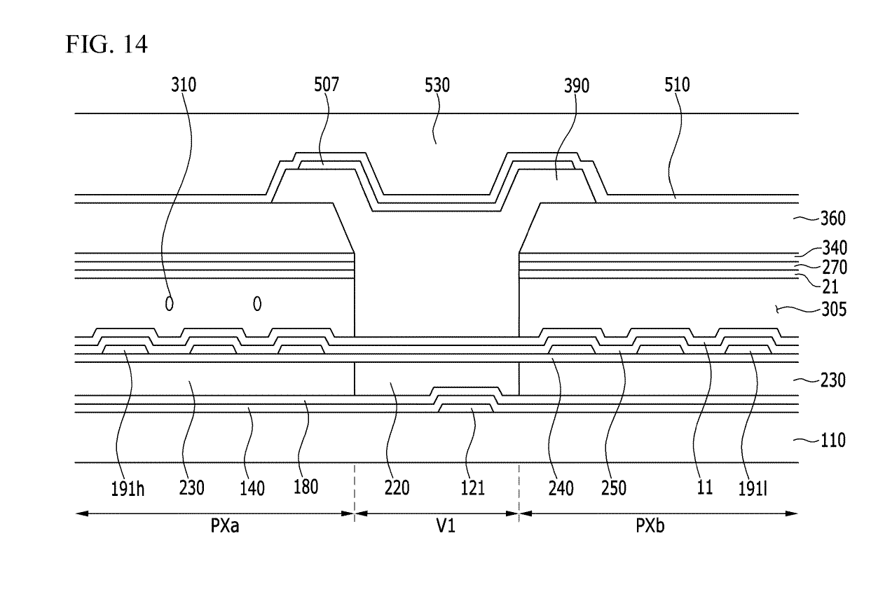

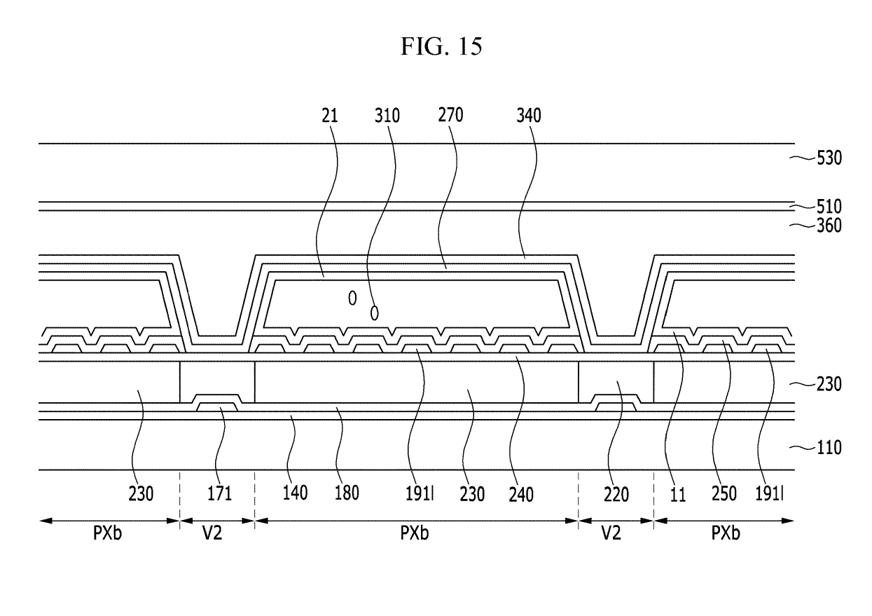

Hereinafter, a liquid crystal display according to another exemplary embodiment of the present disclosure and a method of manufacturing the liquid crystal display are described with reference to FIGS. 14 and 15. Descriptions of the same constituent elements as those of the aforementioned exemplary embodiment(s) are omitted.

According to another exemplary embodiment of the present system and method, a metal layer 507 is positioned on the overcoat 390. A plane shape of the metal layer 507 may be similar to that of the overcoat 390. That is, the metal layer 507 is formed to cover an injection hole 307 and partially overlap a roof layer 360.

The metal layer 507 may be formed by an inkjet method, an aerosol method, or a dispensing method, and may be formed without using a mask, similar to the method of forming the overcoat 390. The metal layer 507 may be one of copper (Cu) and silver (Ag), but is not limited thereto, and any metal material may be used as the metal layer 507 as long as the metal material may be used by the inkjet method or the dispensing method.

The metal layer 507 formed by the aforementioned method may have a thickness of about 1 μm or more so that the metal layer 507 is able to effectively block moisture permeating into the injection hole.

A film layer 510 may be positioned on the metal layer 507. The film layer 510 according to an exemplary embodiment of the present system and method may be a thermosetting epoxy film. When an UV curable film is used, the liquid crystal layer may be influenced according to UV radiation.

According to the exemplary embodiment of FIG. 14, the inorganic layer 517 shown in the embodiment of FIG. 3 may be omitted because moisture permeation is prevented by the metal layer 507.

A flattening layer 530 is positioned on the film layer 510. The flattening layer 530 may be formed of an organic material and flattens steps or bumps that may occur on the surface of the film layer 510. That is, the flattening layer 530 is formed on the inorganic layer 510 to create a uniformly-flat, upper surface.

Although not illustrated in the drawings, a polarizer may be further formed on upper and lower surfaces of the display device. The polarizer may include a first polarizer and a second polarizer. The first polarizer may be attached onto a lower surface of a substrate 110, and the second polarizer may be attached onto the flattening layer 530. Thus, according to an exemplary embodiment of the present system and method, a liquid crystal display may provide a flat surface by means of the flattening layer 530, so that the polarizer may be stably attached to the display panel.

Hereinafter, reliability of the manufacturing process of a liquid crystal display according to an exemplary embodiment of the present system and method is described with reference to FIGS. 16 to 18. FIGS. 16 to 18 are images pertaining to observations of a display device according to an exemplary embodiment of the present system and method.

First, whether the overcoat is stably applied by using a dispenser is investigated with reference to FIG. 16. The overcoat was applied by using a dispenser and subsequently cured at 120° C.

In FIG. 16, the overcoat was not formed for the plurality of pixels positioned in an upper row, but formed for the plurality of pixels positioned in a lower row by using the dispenser.

It was confirmed that leakage of the liquid crystal material from the pixels positioned in the upper row was found, but the liquid crystal material did not leak from the pixels positioned in the lower row. That is, it was confirmed that even when the overcoat was formed to overlap a part of the roof layer while sealing the injection hole (as opposed to being formed on the entire surface of the substrate), the injection hole was stably sealed.

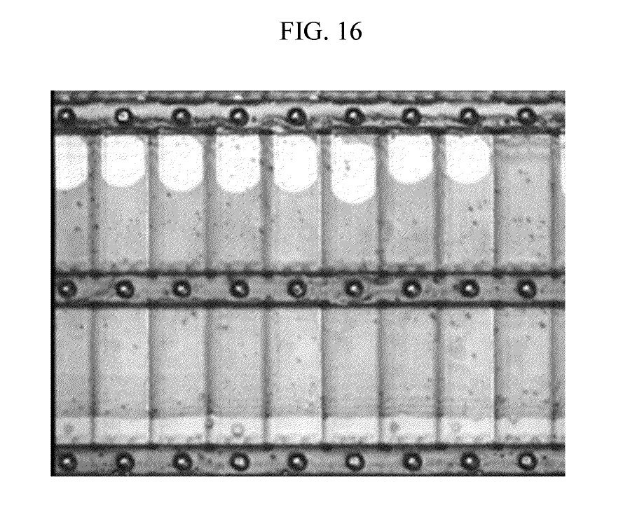

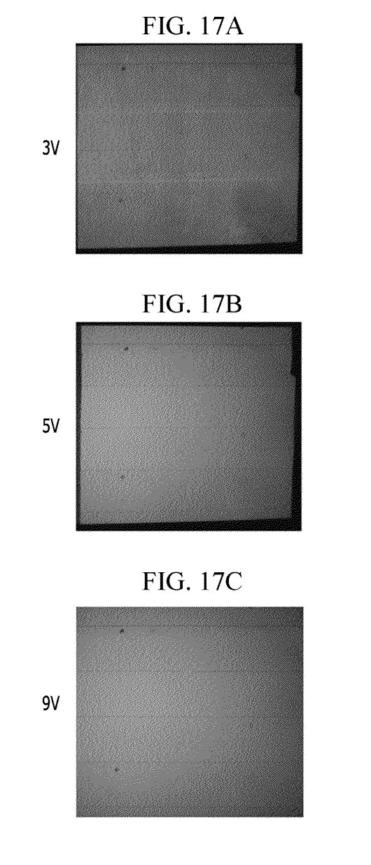

Next, FIGS. 17A to 17C are driving images for the display device in which the film layer is attached on the overcoat. According to an exemplary embodiment of the present system and method, the thermosetting epoxy film layer was attached onto the overcoat at 120° C.

FIG. 17A is a driving image when 3V is applied, FIG. 17B is a driving image when 5V is applied, and FIG. 17C is a driving image when 9V is applied. Referring to FIGS. 17A to 17C, it can be seen that even when the film layer is deposited on the overcoat, the display device may be normally driven according to the application of the voltage.

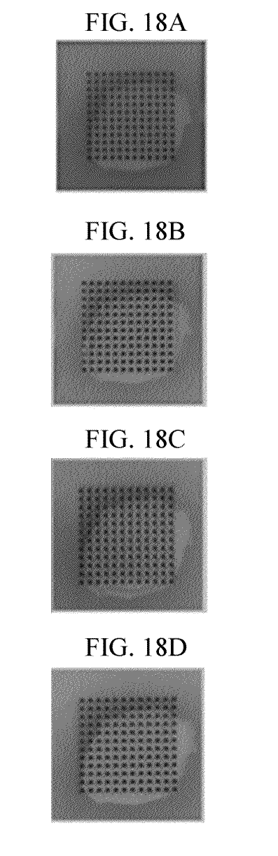

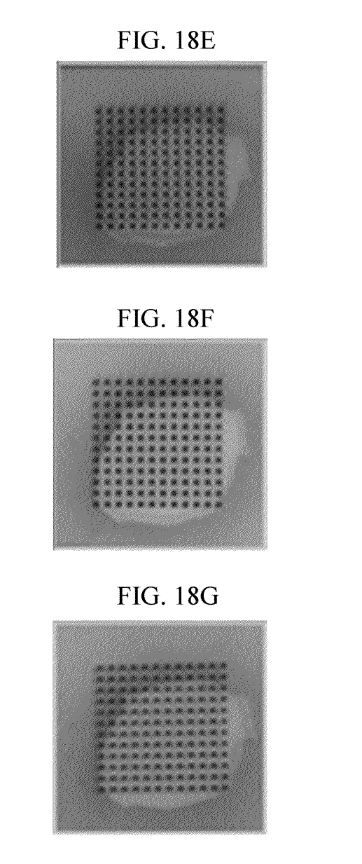

Next, FIG. 18 is an image of a permeation level of a display device according to an exemplary embodiment in which the inorganic layer is formed on the film layer. Particularly, a calcium test was performed on the display device in which the inorganic layer is formed on the film layer by using an aluminum oxide and the ALD method. In the test, whether moisture permeates the inorganic layer and the film layer to react with calcium positioned on a lower surface of the film layer is observed at a temperature of 85° C. and humidity of 85%.

FIG. 18A is an image of the test at an initial stage, FIG. 18B is an image of the test after 12 hours, FIG. 18C is an image of the test after 24 hours, FIG. 18D is an image of the test after 48 hours, FIG. 18E is an image of the test after 72 hours, FIG. 18F is an image of the test after 96 hours, and FIG. 18G is an image of the test after 120 hours.

As illustrated in FIGS. 18A to 18G, it was confirmed that the calcium positioned under the film layer did not react with moisture because the calcium positioned in an almost circular shape maintained its shape and position without deformation throughout the test in FIGS. 18A to 18G.

Further, although a separate experimental result is not attached, it was confirmed that calcium reacted with moisture after 24 hours in a liquid crystal display that includes only a PET film layer.

That is, it was confirmed that the film layer and the inorganic layer according to an exemplary embodiment of the present system and method effectively prevented moisture from permeating.

Thus, according to embodiments of the present system and method, it is possible to prevent moisture from permeating into the display device, and the display panel and the polarizer may be stably attached through a flattened surface of the display panel.

While present system and method are described in connection with exemplary embodiments, the present system and method is not limited to the disclosed embodiments. On the contrary, the present system and method cover various modifications and equivalent arrangements included within the spirit and scope of the appended claims.

<Description of symbols>

| | |
|---|---|
| 11: First alignment layer | 21: Second alignment layer |
| 110: Insulation substrate | 121: Gate line |
| 124h: First gate electrode | 124l: Second gate electrode |
| 124c: Third gate electrode | 131: Storage electrode line |
| 140: Gate insulating layer | 171: Data line |
| 191: Pixel electrode | 191h: First subpixel electrode |
| 191l: Second subpixel electrode | 220: Light blocking member |
| 230: Color filter | 240: First insulating layer |
| 250: Second insulating layer | |
| 270: Common electrode | 300: Sacrificial layer |
| 305: Microcavity | 307: Injection hole |
| 310: Liquid crystal molecule | 340: Third insulating layer |
| 370: Third insulating layer | 390: Overcoat |

What is claimed is:

1. A liquid crystal display, comprising:
an insulating substrate;
a thin film transistor positioned on the insulating substrate;
a pixel electrode connected to the thin film transistor;
a common electrode spaced apart from the pixel electrode while facing the pixel electrode;
a liquid crystal layer positioned between the pixel electrode and the common electrode, and injected into a microcavity corresponding to one pixel;
a roof layer formed on the common electrode;
an injection hole positioned in the roof layer and the common electrode;
an overcoat configured to cover the injection hole and partially overlap the roof layer;
a film layer positioned on the overcoat and the roof layer; and
a flattening layer positioned on the film layer

2. The liquid crystal display of claim 1, further comprising:
an inorganic layer positioned on the film layer.

3. The liquid crystal display of claim 2, wherein:
the inorganic layer includes any one of an aluminum oxide (Al₂O₃) and a titanium oxide (TiO₂).

4. The liquid crystal display of claim 3, wherein:
the inorganic layer overlaps the film layer in a vertical direction with respect to a planar surface of the insulating substrate on which the thin film transistor is positioned.

5. The liquid crystal display of claim 1, wherein:
the film layer is a thermosetting epoxy film.

6. The liquid crystal display of claim 1, further comprising:
a metal layer positioned on the overcoat.

7. The liquid crystal display of claim 6, wherein:
a material of the metal layer includes at least one of copper (Cu) and silver (Ag).

8. A method of manufacturing a liquid crystal display, comprising:
forming a thin film transistor on an insulating substrate;
forming a pixel electrode connected to the thin film transistor;
forming a sacrificial layer on the pixel electrode;
forming a common electrode and a roof layer including an injection hole on the sacrificial layer;
forming a microcavity corresponding to each pixel between the pixel electrode and the common electrode by removing the sacrificial layer exposed through the injection hole;
forming a liquid crystal layer by injecting a liquid crystal material into the microcavity;
forming an overcoat partially overlapping the roof layer to seal the injection hole;
stacking a film layer on the overcoat; and
forming a flattening layer on the film layer.

9. The method of claim 8, further comprising:
forming an inorganic layer on the film layer.

10. The method of claim 9, wherein:
the inorganic layer is formed by an atomic layer deposition (ALD) method, and is formed to overlap the film layer in a vertical direction with respect to a planar surface of the insulating substrate on which the thin film transistor is formed.

11. The method of claim 8, wherein:
the overcoat is formed by a dispensing method.

12. The method of claim 8, wherein:
the film layer is a thermosetting epoxy film.

13. The method of claim 8, further comprising:
forming a metal layer on the overcoat.

14. The method of claim 13, wherein:
the metal layer is formed by a dispensing method or an inkjet printing method.

15. The method of claim 14, wherein:
the metal layer has a thickness of about 1 μm or more.
